(19) United States
(12) Patent Application Publication
(10) Pub. No.: US 2025/0078840 A1
(43) Pub. Date: Mar. 6, 2025

(54) TARGET SPEAKER KEYWORD SPOTTING

(71) Applicant: Google LLC, Mountain View, CA (US)

(72) Inventors: Pai Zhu, New York City, NY (US); Beltrán Labrador Serrano, Madrid (ES); Guanlong Zhao, Long Island City, NY (US); Angelo Alfredo Scorza Scarpati, New York, NY (US); Quan Wang, Hoboken, NJ (US); Alex Seungryong Park, Mountain View, CA (US); Ignacio Lopez Moreno, Jersey City, NJ (US)

(73) Assignee: Google LLC, Mountain View, CA (US)

(21) Appl. No.: 18/812,338

(22) Filed: Aug. 22, 2024

Related U.S. Application Data
(60) Provisional application No. 63/579,951, filed on Aug. 31, 2023.

(51) Int. Cl. G10L 17/02; G10L 17/04; G10L 17/22

(52) U.S. Cl. CPC G10L 17/02; G10L 17/04; G10L 17/22

(57) ABSTRACT

A method includes receiving audio data corresponding to an utterance spoken by a particular user and captured in streaming audio by a user device. The method also includes performing speaker identification on the audio data to identify an identity of the particular user that spoke the utterance. The method also includes obtaining a keyword detection model personalized for the particular user based on the identity of the particular user that spoke the utterance. The keyword detection model is conditioned on speaker characteristic information associated with the particular user to adapt the keyword detection model to detect a presence of a keyword in audio for the particular user. The method also includes determining that the utterance includes the keyword using the keyword detection model personalized for the particular user.

### CROSS REFERENCE TO RELATED APPLICATIONS

This U.S. patent application claims priority under 35 U.S.C. § 119 (e) to U.S. Provisional Application 63/579,951, filed on Aug. 31, 2023. The disclosure of this prior application is considered part of the disclosure of this application and is hereby incorporated by reference in its entirety.

### TECHNICAL FIELD

This disclosure relates to target speaker keyword spotting.

### BACKGROUND

Speech-enabled environments, such as a home, automobile, or schools, users may speak a query or command and a digital assistant may answer the query and cause commands to be performed. In some scenarios, users must precede the spoken query or command with a keyword in order for the digital assistant to process the query or command. The use of keywords prevents the digital assistants from needlessly processing background sounds and speech that are not directed towards the digital assistant. Yet, if a keyword is spoken and not detected, the query or command will not be executed. Thus, accurately detecting spoken keywords for a vast number of users with varying speaking styles is crucial for speech-enabled environments.

### SUMMARY

One aspect of the disclosure provides a computer-implemented method that when executed on data processing hardware causes the data processing hardware to perform operations for target speaker keyword spotting. The operations include receiving audio data corresponding to an utterance spoken by a particular user and captured in streaming audio by a user device. The operations also include performing speaker identification on the audio data to identify an identity of the particular user that spoke the utterance. The operations also include obtaining a keyword detection model personalized for the particular user based on the identity of the particular user that spoke the utterance. The keyword detection model is conditioned on speaker characteristic information associated with the particular user to adapt the keyword detection model to detect a presence of a keyword in audio for the particular user. The operations also include determining that the utterance includes the keyword using the keyword detection model personalized for the particular user.

Implementations of the disclosure may include one or more of the following optional features. In some implementations, the operations further include obtaining a speaker-agnostic keyword detection model trained to detect the presence of the keyword in audio, receiving one or more enrollment utterances spoken by the particular user, extracting a speaker embedding characterizing voice characteristics of the particular user from the one or more enrollment utterances spoken by the particular user, and conditioning the speaker-agnostic keyword detection model on the speaker embedding which includes the speaker characteristics information associated with the particular user.

In these implementations, the keyword detection model may include a Feature-wise Linear Modulation (FILM) layer and conditioning the speaker-agnostic keyword detection model includes generating FiLM parameters based on the speaker embedding using a FiLM generator and modulating the FILM layer of the speaker-agnostic keyword detection model using the FILM parameters to provide the keyword detection model personalized for the particular user. Here, extracting the speaker embedding may include extracting a text-independent speaker embedding or a text-dependent speaker embedding. The speaker-agnostic keyword detection model may include a stack of cross-attention layers and conditioning the speaker-agnostic keyword detection model includes processing the one or more enrollment utterances using the stack of cross-attention layers to provide the keyword detection model personalized for the particular user.

In some examples, obtaining the keyword detection model personalized for the particular user includes retrieving the speaker characteristic information associated with the particular user from memory hardware in communication with the data processing hardware using the identity of the particular user and conditioning a speaker-agnostic keyword detection model on the speaker characteristic information associated with the particular user to provide the keyword detection model personalized for the particular user. Here, the speaker-agnostic keyword detection model is trained to detect the presence of the keyword in audio. In these examples, the speaker characteristic information associated with the particular user may be stored on the memory hardware and include one or more enrollment utterances spoken by the particular user. The speaker characteristic information associated with the particular user may be stored on the memory hardware and include a speaker embedding extracted from one or more enrollment utterances spoken by the particular user. In some implementations, the operations further include processing the streaming audio using a speech recognition model in response to determining that the utterance includes the keyword. The utterance may include a keyword followed by one or more other terms corresponding to a voice command.

Another aspect of the disclosure provides a system that includes data processing hardware and memory hardware storing instructions that when executed on the data processing hardware causes the data processing hardware to perform operations. The operations include receiving audio data corresponding to an utterance spoken by a particular user and captured in streaming audio by a user device. The operations also include performing speaker identification on the audio data to identify an identity of the particular user that spoke the utterance. The operations also include obtaining a keyword detection model personalized for the particular user based on the identity of the particular user that spoke the utterance. The keyword detection model is conditioned on speaker characteristic information associated with the particular user to adapt the keyword detection model to detect a presence of a keyword in audio for the particular user. The operations also include determining that the utterance includes the keyword using the keyword detection model personalized for the particular user.

Implementations of the disclosure may include one or more of the following optional features. In some implementations, the operations further include obtaining a speaker-agnostic keyword detection model trained to detect the presence of the keyword in audio, receiving one or more enrollment utterances spoken by the particular user, extracting a speaker embedding characterizing voice characteristics of the particular user from the one or more enrollment utterances spoken by the particular user, and conditioning the speaker-agnostic keyword detection model on the speaker embedding which includes the speaker characteristics information associated with the particular user. In these implementations, the keyword detection model may include a Feature-wise Linear Modulation (FILM) layer and conditioning the speaker-agnostic keyword detection model includes generating FILM parameters based on the speaker embedding using a FiLM generator and modulating the FILM layer of the speaker-agnostic keyword detection model using the FILM parameters to provide the keyword detection model personalized for the particular user. Here, extracting the speaker embedding may include extracting a text-independent speaker embedding or a text-dependent speaker embedding. The speaker-agnostic keyword detection model may include a stack of cross-attention layers and conditioning the speaker-agnostic keyword detection model includes processing the one or more enrollment utterances using the stack of cross-attention layers to provide the keyword detection model personalized for the particular user.

In some examples, obtaining the keyword detection model personalized for the particular user includes retrieving the speaker characteristic information associated with the particular user from the memory hardware in communication with the data processing hardware using the identity of the particular user and conditioning a speaker-agnostic keyword detection model on the speaker characteristic information associated with the particular user to provide the keyword detection model personalized for the particular user. Here, the speaker-agnostic keyword detection model is trained to detect the presence of the keyword in audio. In these examples, the speaker characteristic information associated with the particular user may be stored on the memory hardware and include one or more enrollment utterances spoken by the particular user. The speaker characteristic information associated with the particular user may be stored on the memory hardware and include a speaker embedding extracted from one or more enrollment utterances spoken by the particular user. In some implementations, the operations further include processing the streaming audio using a speech recognition model in response to determining that the utterance includes the keyword. The utterance may include a keyword followed by one or more other terms corresponding to a voice command.

The details of one or more implementations of the disclosure are set forth in the accompanying drawings and the description below. Other aspects, features, and advantages will be apparent from the description and drawings, and from the claims

### DESCRIPTION OF DRAWINGS

FIGS. 1A and 1B are schematic views of an example system having a speaker verification system and a keyword detector.

FIGS. 2A and 2B are schematic views of the speaker verification system of FIGS. 1A and 1B.

FIG. 3 is a schematic view of an example training process for training the multilingual speaker verification system.

FIGS. 4A and 4B are schematic views of an example conditioning process for conditioning the keyword detector from FIGS. 1A and 1B.

FIG. 5 is a flowchart of an example arrangement of operations for a method of performing target speaker keyword spotting.

FIG. 6 is a schematic view of an example computing device that may be used to implement the systems and methods described herein.

Like reference symbols in the various drawings indicate like elements.

### DETAILED DESCRIPTION

Keyword spotting enables speech recognition systems to avoid unnecessary processing of speech that is not directed towards speech-enabled devices and other background noises. In particular, keyword or hotword spotting requires users to precede voice commands or queries with a particular keyword such as “Hey Google” or “Ok Google.” As such, speech recognition systems will not process received audio data unless a keyword detector detects the predetermined keyword. However, a major drawback to using keywords is in scenarios where a user speaks the keyword but the keyword detector fails to detect that the keyword was spoken. As a result, the voice command or query that the user spoke after the keyword is never processed by the speech recognition system.

Typically these keyword models are trained on hundreds, thousands, or even millions of hours of speech in order to accurately detect the keywords in audio. The training data includes speech from a plurality of users with different speaking styles, languages, accents, and dialects. Yet, some rare speaking traits may be underrepresented in this training data or even not included at all such that the keyword detectors are unable to detect spoken keywords by users with these rare speaking traits. Namely, these rare speaking traits may include, but are not limited to, rare languages or accents, speech impediments, and children's speech, to name a few. Thus, these users may have a poor experience with speech recognition systems that are unable to detect when they are speaking the keyword.

Accordingly, implementations herein are directed towards systems and methods of target speaker keyword spotting. For instance, the method includes receiving audio data corresponding to an utterance (e.g., an utterance that includes a keyword) spoken by a user and performing speaker identification. Based on an identity of the particular user that spoke the utterance, the method includes obtaining a keyword detection model personalized for the particular user. The personalized keyword detection model is conditioned on speaker characteristic information associated with the particular user. The conditioning may include adapting a baseline or speaker-agnostic keyword detection model to detect a presence of a keyword in audio for the particular user. Thereafter, the personalized keyword detection model may detect that the utterance includes the keyword spoken by the particular user. Notably, the particular user may have rare speaking traits such that only the personalized keyword detection model consistently detects the keyword accurately unlike speaker-agnostic keyword detection models.

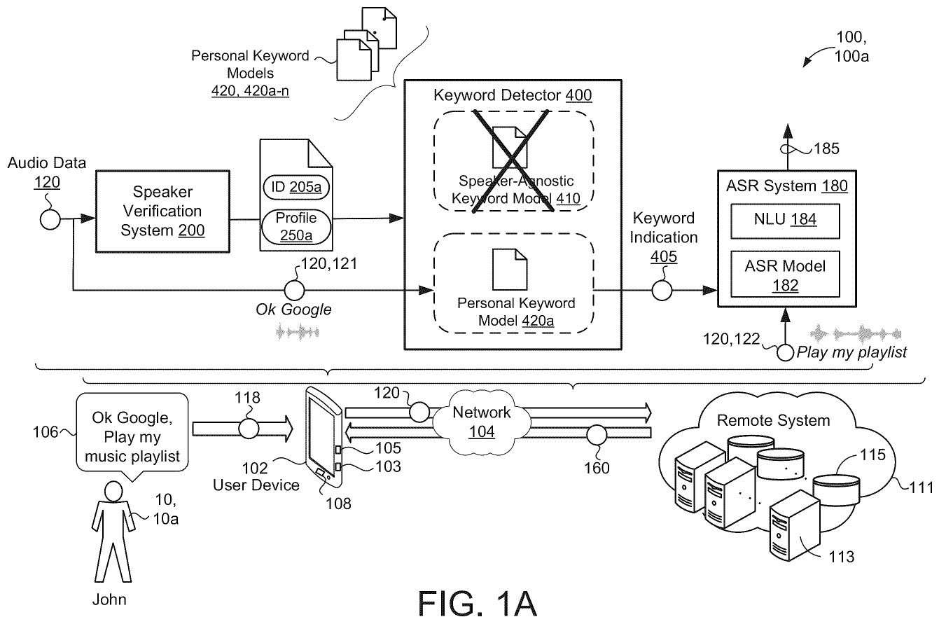

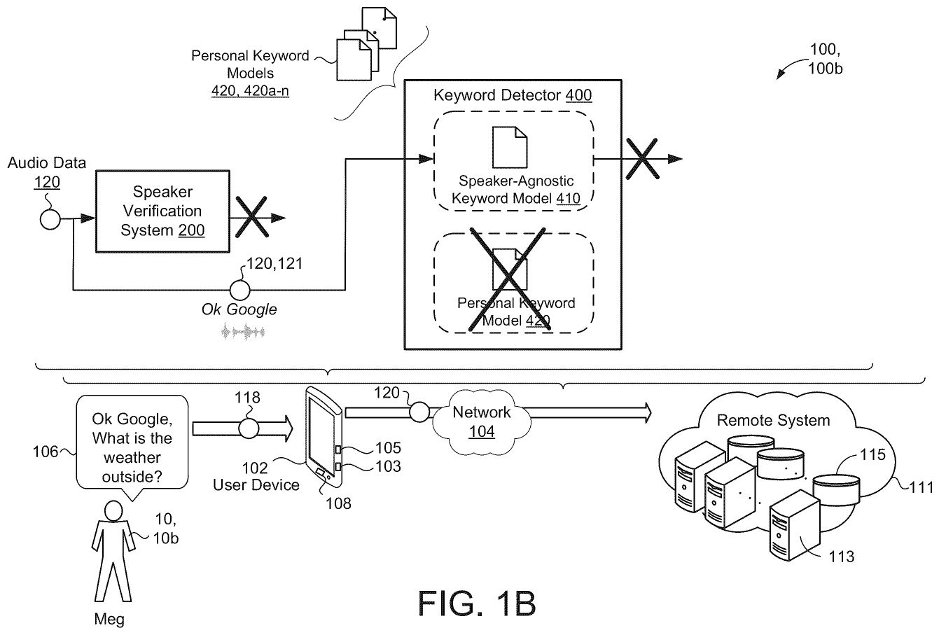

Referring to FIGS. 1A and 1B, in some implementations, a system 100 includes a user device 102 associated with one or more users 10 and is in communication with a remote system 111 via a network 104. The user device 102 may correspond to a computing device, such as a mobile phone, computer (laptop or desktop), tablet, smart speaker/display, smart appliance, smart headphones, wearable device, vehicle infotainment system, etc., and is equipped with data processing hardware 103 and memory hardware 105. The user device 102 includes, or is in communication with, one or more microphones 108 for capturing utterances 106 spoken by the one or more users 10. The remote system 111 may be a single computer, multiple computers, or a distributed system (e.g., a cloud computing environment) having scalable/elastic computing resources (e g., data processing hardware) 113 and/or storage resources (e.g., memory hardware) 115.

The user device 102 includes a keyword detector 400 (also referred to as a keyword detection model and/or hotword detector) configured to detect the presence of a keyword or hotword in streaming audio 118 without performing semantic analysis or speech recognition processing on the streaming audio. In some examples, the keyword detector 400 is configured to detect the presence of any one of multiple keywords (e.g., hotwords). The user device 102 may include an acoustic feature extractor (not shown) which extracts audio data 120 from the utterances 106 spoken by the users 10. The audio data 120 may include acoustic features such as Mel-frequency cepstrum coefficients (MFCCs) or filter bank energies computed over windows of an audio signal. In the examples shown, a first user 10, 10a (e.g., John) speaks the utterance 106 of “Ok Google, Play my music playlist” (FIG. 1A) and a second user 10, 10b speaks the utterance 106 of “Ok Google, What is the weather outside?” (FIG. 1B).

The keyword detector 400 may receive the audio data 120 to determine whether the spoken utterance 106 includes a particular keyword (e.g., Ok Google). That is, the keyword detector 400 may be trained to detect the presence of the particular keyword (e.g., Ok Google) or one or more variations of the keyword (e.g., Hey Google) in the audio data 120. In response to detecting the particular keyword, the keyword detector 400 generates a keyword indication 405 causing the user device 102 to wake-up from a sleep state (e.g., low-power state) and trigger an automated speech recognition (ASR) system 180 to perform speech recognition on the keyword and/or one or more other terms that follow the keyword (e.g., a voice query/command that follows the keyword and specifies a particular action to perform). On the other hand, when the keyword detector 400 does not detect the presence of the keyword, the user device 102 remains in the sleep state such that the ASR system 180 does not process the audio data 120. Advantageously, keywords are useful for “always on” systems that may potentially pick up sounds or utterances that are not directed toward the user device 102. For example, the use of keywords may help the user device 102 discern when a given utterance 106 is directed at the user device 102, as opposed to a different given utterance 106 that is not directed at the user device 102 or a background noise As such, the user device 102 may avoid triggering computationally expensive processing (e.g., speech recognition and semantic interpretation) on sounds or utterances 106 that do not include the keyword.

In some implementations, the keyword detector 400 employs a speaker-agnostic keyword detection model 410. That is, the speaker-agnostic keyword detection model 410 uses the same model without any regard to an identity of the user. Stated differently, the speaker-agnostic keyword detection model 410 processes audio data 120 to detect whether the keyword is present in the same manner for all users. Here, the speaker-agnostic keyword detection model 410 may be trained on training data spoken by multiple different speakers in multiple different languages, accents, and/or dialects to learn to detect the presence of the keyword in audio for a plurality of users 10. That is, the speaker-agnostic keyword detection model 410 may include a general model that is not trained to detect the keyword for any particular user, but is trained to detect the keyword when any user 10 from the one or more users 10 speak. Yet, in these examples, despite training the speaker-agnostic keyword detection model 410 on thousands or even millions of hours of training data, the speaker-agnostic keyword detection model 410 may be unable to accurately detect the presence of the keyword in audio for certain users 10 Namely, users 10 with rare or unseen voice characteristics included in the training data, such as, speech impediments (e.g., stuttering), unseen dialects (e.g., Rangpuri dialect), and children's speech. Simply put, because these rare or unseen voice characteristics were not included in the training data, the speaker-agnostic keyword detection model 410 is unable to accurately detect the presence of the keyword in audio for certain users 10. For example, a child user may speak “Hey Google, Tell me a story,” but if the speaker-agnostic keyword detection model 410 fails to detect the presence of the keyword “Hey Google,” then the ASR system 180 will not process the query of “Tell me a story” thereby degrading the experience for the user 10.

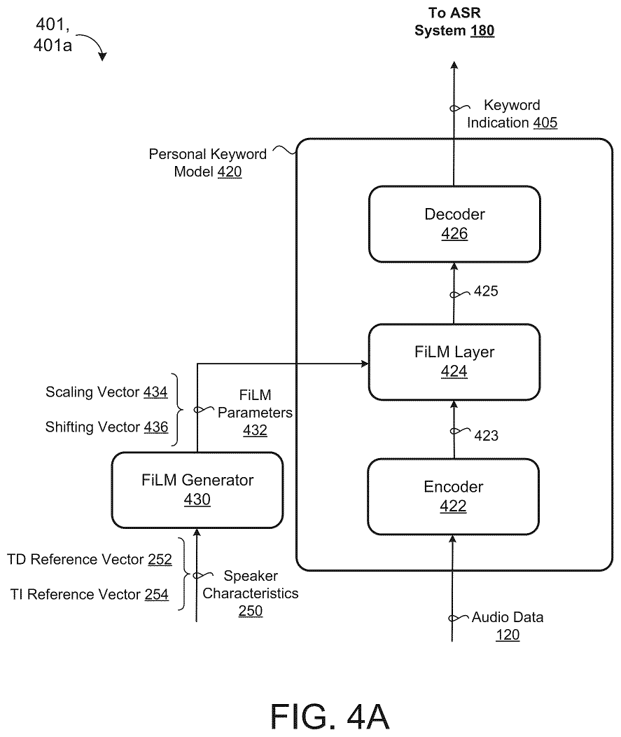

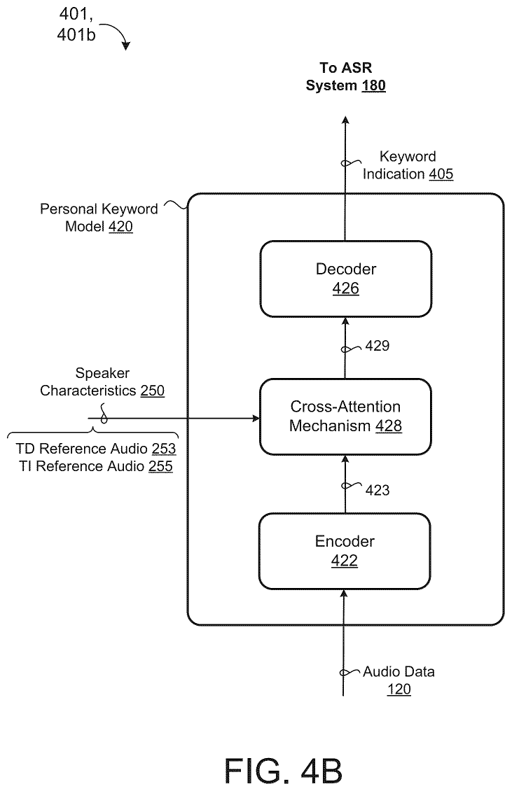

To that end, the keyword detector 400 may store a plurality of personal keyword detection models 420, 420a-n each personalized for a particular enrolled user 10 from multiple enrolled users 10. Discussed with greater detail with respect to FIG. 4, the personal keyword detection models 420 are conditioned on speaker characteristic information associated with the particular users 10 to adapt the keyword detector 400 to detect the presence of the keyword in audio for the particular enrolled user 10. Stated differently, a personal keyword detection model 420 for a particular user 10 may detect the keyword spoken by the particular user 10 (e.g., user with rare or unseen speaker characteristics) that the speaker-agnostic keyword detection model 410 is unable to detect. As such, before detecting whether audio includes the keyword, the system 100 employs a speaker verification system 200 that is configured to determine an identity 205 of the user 10 that is speaking the utterance 106. Thus, by determining the identity 205 of the user 10 that is speaking the utterance 106 before detecting whether the keyword is present, the system 100 can obtain speaker characteristic information 250 associated with the enrolled user 10 to process the utterance 106 with the personal keyword detection model 420 (rather than the speaker-agnostic keyword detection model 410).

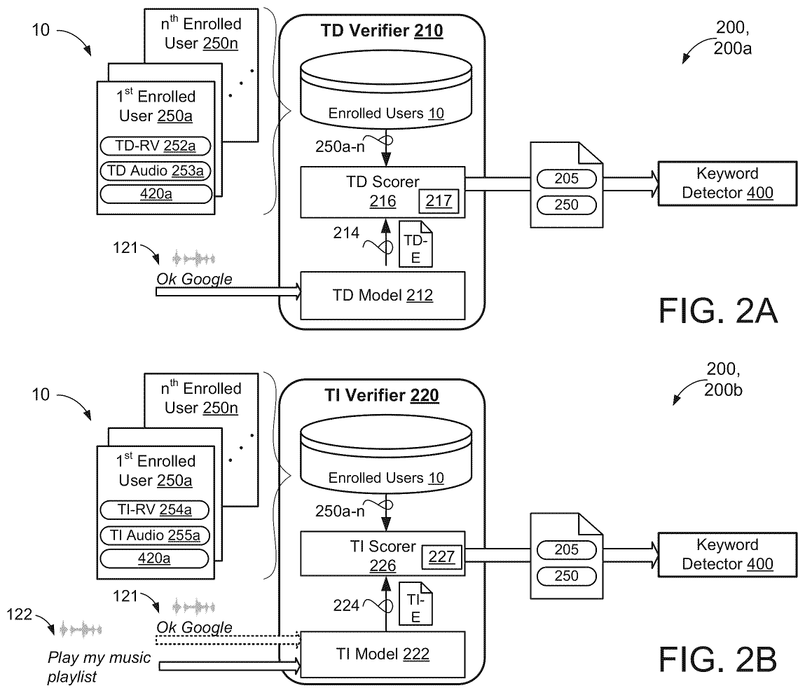

Referring now to FIGS. 2A and 2B, in some implementations, users 10 associated with the user device 102 may undertake a voice enrollment process to generate speaker characteristic information (e.g., user profile) 250 associated with each respective enrolled user 10. That is, the speaker verification system 200 may obtain respective enrollment reference vectors (e.g., speaker embeddings) 252, 254 and/or respective enrollment reference audio data 253, 255 from audio samples of one or more enrollment phrases spoken by the user 10 during the enrollment process. In some examples, the one or more enrollment phrases spoken by the user during enrollment may be a predetermined term/phrase (e.g., the keyword the keyword detector 400 is configured to detect) such that the enrollment process generates a text-dependent reference vector (e.g., text-dependent speaker embedding) 252 or text-dependent reference audio data 253. In other examples, the one or more enrollment phrases spoken by the user during enrollment includes free-form terms/phrases that are not predetermined such that the enrollment process generate a text-independent reference vector (e.g., text-independent speaker embedding) 254 or text-independent reference audio data 255. Discussed in greater detail with reference to FIGS. 4A and 4B, the enrollment reference vectors 252, 254 and/or the enrollment reference audio data 253, 255 may be used to condition the keyword detector 400 to detect the presence of the keyword.

Referring now specifically to FIG. 2A, in some examples, a first example speech verification system 200, 200a includes a text-dependent (TD) verifier 210 that has a TD speaker verification model 212 and a TD scorer 216. Moreover, the TD verifier 210 may store the speaker characteristic information (e.g., user profiles) 250, 250a-n in connection with the identities 205 of enrolled users 10. The TD speaker verification model 212 may generate one or more TD reference vectors (e.g., TD-RV) 252 from a predetermined term spoken in enrollment phrases by each enrolled user 10 that may be combined (e.g., averaged or otherwise accumulated) to form the respective TD reference vector 252. Here, the predetermined term spoken by each enrolled user 10 may be the predetermined keyword or another predetermined term. The TD verifier 210 stores the TD reference vector 252 in connection with the respective user profile 250 associated with the user 10 that spoke the enrollment utterance. In some examples, in addition to, or in lieu of, storing the TD reference vector 252 the TD verifier 210 stores the TD reference audio data 253 in connection with the respective user profile 250 associated with the user 10 that spoke the enrollment utterance. That is, instead of generating a reference vector 252 from the enrollment utterances, the TD verifier 210 stores the TD reference audio data 253 directly. Moreover, TD verifier 210 may store the personalized keyword detection model 420 in connection with the respective user profile 250 associated with the user 10 that spoke the enrollment utterance.

In some examples, after a user has performed the enrollment process, the TD verifier 210 performs speaker identification on the audio data 120 to identify the identity 205 of the particular user that spoke the utterance. The TD verifier 210 identifies the user 10 that spoke the utterance 106 by first extracting, from the first portion 121 of the audio data 120 that characterizes the predetermined keyword spoken by the user, a TD evaluation vector (e.g., TD-E) 214 representing voice characteristics of the utterance of the keyword. Here, the TD verifier 210 may execute the TD speaker verification model 212 configured to receive the first portion 121 (e.g., characterizing the portion of the utterance corresponding to the keyword) of the audio data as input and generate, as output, the TD evaluation vector 214. The TD speaker verification model 212 may be a neural network model trained using machine or human supervision to output the TD evaluation vector 214.

Once the TD evaluation vector 214 is output from the TD speaker verification model 212, the TD verifier 210 determines whether the TD evaluation vector 214 matches any of the stored user profiles 250 (e.g., stored at the memory hardware 105 and/or the memory hardware 115) in connection with identities 205 of the enrolled users 10. In particular, the TD verifier 210 may compare the TD evaluation vector 214 to the TD reference vector 252 or the TD reference audio data 253. Here, each TD reference vector 252 may be used as a reference vector corresponding to a voiceprint or unique identifier representing characteristics of the voice of the respective enrolled user 10 speaking the predetermined keyword.

In some implementations, the TD verifier 210 uses a TD scorer 216 that compares the TD evaluation vector 214 to the respective TD reference vector 252 associated with each enrolled user 10 of the user device 102. Here, the TD scorer 216 may generate a score for each comparison indicating a likelihood that the utterance 106 corresponds to an identity 205 of the respective enrolled user 10. Specifically, the TD scorer 216 generates a TD confidence score 217 for each enrolled user 10 of the user device 102. In some implementations, the TD scorer 216 determines the TD confidence score by determining a respective cosine distance between the TD evaluation vector 214 and each TD reference vector 252 to generate the TD confidence score 217 for each respective enrolled user 10.

Thereafter, the TD scorer 216 determines whether any of the TD confidence scores 217 satisfy a confidence threshold. When the TD confidence score 217 satisfies the confidence threshold, the TD scorer 216 outputs the identity 205 of the particular user that spoke the utterance and the associated user profile 250 to the keyword detector 400. On the other hand, when the TD confidence score fails to satisfy the confidence threshold, the TD scorer 216 does not output any identity or user profile 250 to the keyword detector 400.

Referring now to FIG. 2B, in some examples, a second example speech verification system 200, 200b includes a text-independent (TI) verifier 220 that has a TI speaker verification model 222 and a TI scorer 226. Moreover, the TI verifier 220 may store the user profiles 250, 250a-n in connection with the identities 205 of enrolled users. The TI speaker verification model 222 may generate one or more TI reference vectors (e.g., TI-RV) 254 from audio samples of enrollment phrases spoken by each enrolled user that may be combined (e.g., averaged or otherwise accumulated) to form the respective TI reference vector 254. Here, the enrollment phrases spoken may be free-form users including any speech the user wishes to speak. Thus, the enrollment phrases may be different than the keyword or any phrase the user wishes to speak. The TI verifier 220 stores the TI reference vector 254 in connection with the respective user profile 250 associated with the user 10 that spoke the enrollment utterance. In some examples, in addition to, or in lieu of, storing the TI reference vector 254 the TI verifier 220 stores the TI reference audio data 255 in connection with the respective user profile 250 associated with the user 10 that spoke the enrollment utterance. That is, instead of generating a TI reference vector 254 from the enrollment utterances, the TI verifier 220 stores the TI reference audio data 255 directly. Moreover, the TI verifier 220 may store the personalized keyword detection model 420 in connection with the respective user profile 250 associated with the user 10 that spoke the enrollment utterance.

In some examples, after a user has performed the enrollment process, the TI verifier 220 performs speaker identification on the audio data 120 to identify the identity 205 of the particular user that spoke the utterance. The TI verifier 220 identifies the user 10 that spoke the utterance 106 by first extracting, from the second portion 122 of the audio data 120 that characterizes the query including free-form speech or the query following the predetermined keyword spoken by the user, a TD evaluation vector (e.g., TD-E) 214 representing voice characteristics of the utterance. Here, the TI verifier 220 may execute the TD speaker verification model 212 configured to receive the first portion 121 of the audio data as input and generate, as output, the TD evaluation vector 214. The TI speaker verification model 222 may be a neural network model trained using machine or human supervision to output the TI evaluation vector 224.

Once the TI evaluation vector 224 is output from the TI speaker verification model 222, the TI verifier 220 determines whether the TI evaluation vector 224 matches any of the stored user profiles 250 (e.g., stored at the memory hardware 105 and/or the memory hardware 115) in connection with identities 205 of the enrolled users 10. In particular, the TI verifier 220 may compare the TI evaluation vector 224 to the TI reference vector 254 or the TI reference audio data 255. Here, each TI reference vector 254 may be used as a reference vector corresponding to a voiceprint or unique identifier representing characteristics of the voice of the respective enrolled user 10.

In some implementations, the TI verifier 220 uses a TI scorer 226 that compares the TI evaluation vector 224 to the respective TI reference vector 254 associated with each enrolled user 10 of the user device 102. Here, the TI scorer 226 may generate a score for each comparison indicating a likelihood that the utterance 106 corresponds to the identity 205 of the respective enrolled user 10. Specifically, the TI scorer 226 generates a TI confidence score 227 for each enrolled user 10 of the user device 102. In some implementations, the TI scorer 226 determines the TI confidence score 227 by determining a respective cosine distance between the TI evaluation vector 224 and each TI reference vector 254 to generate the TI confidence score 227 for each respective enrolled user 10.

Thereafter, the TI scorer 226 determines whether any of the TI confidence scores 227 satisfy a confidence threshold. When the TI confidence score 227 satisfies the confidence threshold, the TI scorer 226 outputs the identity 205 of the particular user that spoke the utterance and the associated user profile 250 to the keyword detector 400. On the other hand, when the TI confidence score 227 fails to satisfy the confidence threshold, the TI scorer 226 does not output any identity or user profile 250 to the keyword detector 400.

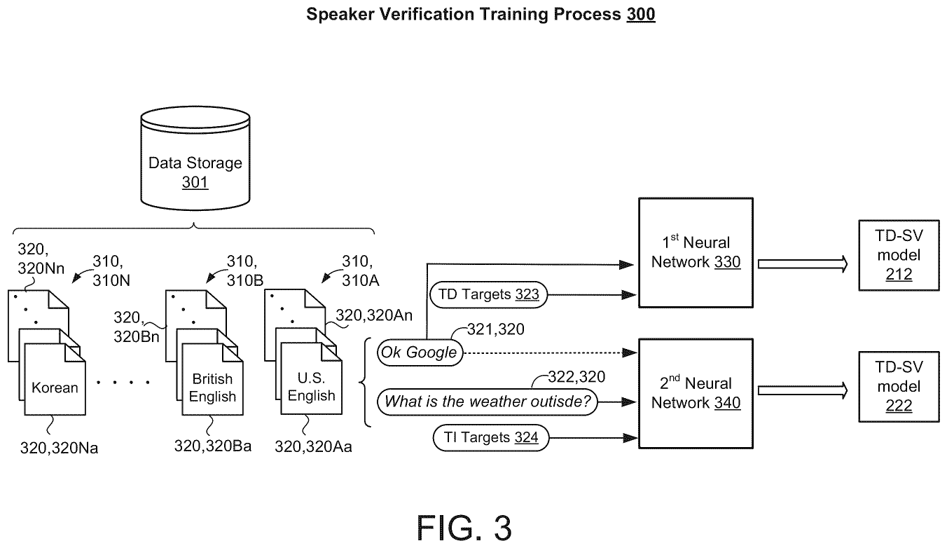

FIG. 3 shows an example speaker verification training process 300 for training the speaker verification system 200. The example speaker verification training process 300 (also referred to as simply “training process 300”) obtains a plurality of training datasets 310, 310A-N stored in data storage 301 and trains each of the TD speaker verification model 212 and the TI speaker verification model 222 on the training datasets 310. Each training dataset 310 may be associated with a different respective language or dialect and includes corresponding training utterances 320, 320Aa-Nn spoken in the respective language or dialect by different speakers. For instance, a first training dataset 310A may be associated with American English speakers that include corresponding training utterances 320Aa-An each spoken in English by speakers from the United States of America. That is, the training utterances 320Aa-An in the first training dataset 310A are all spoken in English with an American accent. On the other hand, a second training dataset 310B may be associated with British English speakers that includes corresponding training utterances 320Ba-Bn also spoken in English, but by speakers from Great Britain. Accordingly, the training utterances 320Ba-Bn in the second training data set 310B are spoken in English with a British accent, and are therefore associated with a different dialect (i.e., British Accent) than the training utterances 320Aa-An associated with the American accent dialect. Notably, an English speaker with a British accent may pronounce some words differently than another English speaker with an American accent. FIG. 3 also shows another training data set 310N associated with Korean that includes corresponding training utterances 320Na-Nn spoken by Korean speakers.

Each corresponding training utterance includes a text-dependent (TD) portion 321 and a text-independent (TI) portion 322. The TD portion 321 includes an audio segment characterizing a predetermined keyword (e.g., “Hey Google”) or a variant of the predetermined keyword (e.g., “Ok Google”) spoken in the training utterance 320. Here, the predetermined keyword and variant thereof may each be detectable by the keyword detector 400 when spoken in streaming audio 118 to trigger the user device to wake-up and initiate speech recognition on one or more terms following the predetermined hotword or variant thereof. In some examples, the fixed-length audio segment associated with the TD portion 321 of the corresponding training utterance 320 that characterizes the predetermined keyword is extracted by the keyword detector 400.

The TI portion 322 in each training utterance 320 includes an audio segment that characterizes a query statement spoken in the training utterance 320 following the predetermined hotword characterized by the TD portion 321. For instance, the corresponding training utterance 320 may include “Ok Google, What is the weather outside?” whereby the TD portion 321 characterizes the hotword “Ok Google” and the TI portion 322 characterizes the query statement “What is the weather outside?” While the TD portion 321 in each training utterance 320 is phonetically constrained by the same predetermined keyword or variation thereof, the lexicon of the query statement characterized by each TI portion 322 is not constrained such that the duration and phonemes associated with each query statement is variable. Notably, the language of the spoken query statement characterized by the TD portion 321 includes the respective language associated with the training dataset 310. For instance, the query statement

“What is the weather outside” spoken in English translates to “Cual es el clima afuera” when spoken in Spanish. In some examples, the audio segment characterizing the query statement of each training utterance 320 includes a variable duration ranging from 0.24 seconds to 1.60 seconds.

With continued reference to FIG. 3, the training process 300 trains a first neural network 330 on the TD portions 321 of the training utterances 320, 320Aa-Nn spoken in the respective language or dialect associated with each training dataset 310, 310A-N. During training, additional information about the TD portions 321 may be provided as input to the first neural network 330. For instance, text-dependent (TD) targets 323 corresponding to ground-truth output labels for training the TD speaker verification model 212 to learn how to predict may be provided as input to the first neural network 330 during training with the TD portions 321. The TD targets 323 may be ground-truth labels for TD evaluation vectors 214 (e.g., when training on TD reference vectors 252) or ground-truth labels for TD audio (e.g., when training on TD reference audio data 253). Thus, one or more utterances of the predetermined keyword from each particular speaker may be paired with a particular TD target 323.

The first neural network 330 may include a deep neural network formed from multiple long short-term memory (LSTM) layers with a projection layer after each LSTM layer. In some examples, the first neural network uses 128 memory cells and the projection size is equal to 64. The TD speaker verification model 212 includes a trained version of the first neural network 330. The TD evaluation and reference vectors 214, 252 generated by the TD speaker verification model 212 may include d-vectors or i-vectors with an embedding size equal to the projection size of the last projection layer. The training process may use generalized end-to-end contrast loss for training the first neural network 330.

After training, the first neural network 330 generates the TD speaker verification model 212. The TD speaker verification model 212 may be pushed to a plurality of user device 102 distributed across multiple geographical regions and associated with users that speak different languages, dialects, or both. The user devices 102 may store and execute the TD speaker verification model 212 to perform text-dependent speaker verification on audio segments characterizing the predetermined keyword spoken by any of the enrolled users of the user device 102.

The training process 300 also trains a second neural network 340 on the TI portions 322 of the training utterances 320, 320Aa-Nn spoken in the respective language or dialect associated with each training dataset 310, 310A-N. Here, for the training utterance 320Aa, the training process 300 trains the second neural network 340 on the TI portion 322 characterizing the query statement “what is the weather outside” spoken in American English. Optionally, the training process 300 may also trains the second neural network 340 on the TD portion 321 (not shown) of at least one corresponding training utterance 320 in one or more of the training datasets 310 in addition to the TI portion 322 of the corresponding training utterance 320. For instance, using the training utterance 320Aa above, the training process 300 may train the second neural network 340 on the entire utterance “Ok Google, what is the weather outside” During training, additional information about the TI portions 322 may be provided as input to the second neural network 340. For instance, TI targets 324 corresponding to ground-truth output labels for training the TI speaker verification model 222 to learn how to predict may be provided as input to the second neural network 340 during training with the TI portions 322. The TI targets 324 may be ground-truth labels for TI evaluation vectors 224 (e.g., when training on TI reference vectors 254) or ground-truth labels for TI audio (e.g., when training on TI reference audio data 255). Thus, one or more utterances of query statements from each particular speaker may be paired with a particular TI target 324.

The second neural network 340 may include a deep neural network formed from LSTM layers with a projection layer after each LSTM layer. In some examples, the second neural network uses 384 memory cells and the projection size is equal to 128. The TI speaker verification model 222 includes a trained version of the second neural network 340. The TI evaluation and reference vectors 252, 254 generated by the TI speaker verification model 222 may include d-vectors or i-vectors with an embedding size equal to the projection size of the last projection layer. The training process 300 may use generalized end-to-end contrastive losses for training the first and second neural networks 330, 340.

Referring back to FIG. 1A, in some examples, for a first example system 100, 100a the first user 10a (e.g., John) speaks the utterance 106 of “Hey Google, Play my music Playlist.” Notably, the first user 10a is an enrolled user that the speaker verification system 200 generated first speaker characteristic information (e.g., user profile) 250. Thus, the speaker verification system 200 identifies a first identity 205a and a first user profile 250a associated with the first user 10a by processing the utterance 106. The keyword detector 400 receives the first identity 205a and first user profile 250a associated with the first user 10a and obtains a first personal keyword detection model 420a associated with the first user 10a. In some examples, the keyword detector 400 obtains the first personal keyword detection model 420a from the first profile 250a sent by the speaker verification system. In other examples, the keyword detector obtains the first personal keyword detection model 420a based on the first identity 205a associated with the first user 10a received from the speaker verification system 200.

Described in greater detail with reference to FIGS. 4A and 4B, the first personal keyword detection model 420a is conditioned on speaker characteristic information 250 (e.g., reference vectors 252, 254, and/or reference audio data 253, 255 (FIGS. 2A and 2B)) associated with the first user 10a to adapt the keyword detector 400 to detect the presence of the keyword in audio for the first user 10a. Accordingly, based on obtaining the first personal keyword detection model 420a, the keyword detector 400 uses the first personal keyword detection model 420a to determine whether the audio data 120 (e.g., the first portion 121 of the audio data 120) includes the keyword instead of using the speaker-agnostic keyword detection model 410 (denoted by the “X” through the speaker-agnostic keyword detection model 410). Notably, the first user 10a has rare/unseen speech characteristics not included in training data used to train the speaker-agnostic keyword detection model 410. For instance, the first user 10a may have a speech impediment, rare accent or dialect, or be a child. Thus, because of the rare speech characteristics of the first user 10a, the speaker-agnostic keyword detection model 410 would not detect the presence of the keyword in audio, but the first personal keyword detection model 420a accurately detects the keyword. That is, since the first personal keyword detection model 420a is conditioned on speaker characteristic information 250 of the first user 10a, the first personal keyword detection model 420a is able to correctly detect the keyword spoken by the first user 10a that a general keyword detector (e.g., not conditioned for the first user 10a) is otherwise unable to detect accurately on a consistent basis.

Based on detecting the presence of the keyword from the audio data 120, the keyword detector 400 outputs the keyword indication 405 to the ASR system 180. In response to receiving the keyword indication 405, the ASR system 180 processes the second portion 122 of the utterance 106 of “Play my playlist” spoken by the first user 10a. In particular, the ASR system 180 includes an ASR model 182 configured to perform speech recognition on the second portion 122 of the audio data 120 that characterizes the query. The ASR system 180 also includes a natural language understanding module (NLU) 184 configured to perform query interpretation on the speech recognition result output by the ASR model 182. Generally, the NLU module 184 may perform semantic analysis on the speech recognition result to identify the action to perform that is specified by the query. In some examples, the ASR system 180 receives the first identity 205a and the first user profile 250a associated with the first user 10a, and personalizes the speech recognition for the first user 10a. For instance, the ASR system 180 may determine the “music playlist” from the utterance 106 is referencing a music playlist associated with the first user 10a. Thereafter, the user device 102 may send the response including an audio track from John's music playlist for the user device 102 to play for audible output from a speaker.

Referring now to FIG. 1B, in some examples, for a second example system 100, 100b the second user 10b (e.g., Meg) speaks the utterance 106 of “Hey Google, what is the weather outside?” Notably, the utterance includes the keyword “Hey Google,” but the second user is not an enrolled user. That is, the second user 10b did not undergo the speaker enrollment process such that there is not any stored speaker characteristic information 250 associated with the second user 10b. Thus, the speaker identification system does not identify any identity 205 nor user profile 250 associated with the second user 10b by processing the utterance 106 because the second user 10b is not an enrolled user. For instance, the second user may be a guest at the house of another user or using a mobile device of the other user that has enrolled with the user device 102.

Despite not being an enrolled user, the keyword detector 400 still receives the first portion 121 (e.g., characterizing the keyword portion of the audio data 120) but processes the first portion 121 using the speaker-agnostic keyword detection model 410 instead of a personal keyword detection model 420. That is, because no personal keyword detection model 420 exists for the second user 10b, the keyword detector 400 uses the speaker-agnostic keyword detection model 410 that is not conditioned on speaker characteristic information 250 of the second user 10b. Yet, the second user 10b may have the same rare/unseen speech characteristics as the first user 10a (FIG. 1A) that was not included in the training data used to train the speaker-agnostic keyword detection model 410 such that the keyword is not detected by the keyword detector 400. Notably, if the second user 10b had become an enrolled user with a respective personal keyword detection model 420, the keyword detector 400 would have detected the presence of the keyword because of the conditioning based on the speaker characteristic information of the second user 10b. Moreover, since the keyword detector 400 failed to detect the presence of the keyword that was actually spoken by the second user 10b, the ASR system 180 does not process the second portion 122 of the audio data 120. That is, the ASR system 180 only processes the second portion 122 when the keyword indication 405 is received. Thus, the query spoken by the second user 10b is not processed by the ASR system 180.

FIGS. 4A and 4B show an example conditioning process 401 for conditioning the keyword detector 400 on speaker characteristic information 250. In some implementations, the conditioning process 401 occurs during the enrollment process described with reference to FIGS. 2A and 2B. That is, after generating the speaker characteristic information 250 for the user 10 that spoke the enrollment utterances, the conditioning process 401 may condition the keyword detector 400 such that the personal keyword detection model 420 is pre-determined before the user 10 speaks any utterances 106 directed towards the user device 102. Advantageously, performing the conditioning process 401 in this manner limits computational resources (and therefore the observed latency) when the enrolled user 10 speaks the utterance 106 that is directed towards the user device 102 to perform some action. In other implementations, the conditioning process 401 occurs as the user speaks utterances 106 directed towards the user device 102. For instance, the conditioning process 401 would not occur until after the first user 10a spoke the utterance 106 of “Hey Google, play my music playlist” in an on-the-fly configuration by obtaining the speaker characteristic information 250 from memory hardware 105, 115 in communication with the data processing hardware 103, 113. The conditioning process 401 may occur at the remote system 111 and/or the user device 102.

Referring now to FIG. 4A, in some examples, a first example conditioning process 401, 401a uses the speaker characteristic information 250 that includes the reference vectors 252, 254 to condition the keyword detector 400. Here, the first example conditioning process 401 employs a feature-wise linear modulation (FILM) generator 430 configured to receive, as input, the TD reference vector 252 and/or the TI reference vector 254 generated for an enrolling user 10 and generate, as output, FILM parameters 432 based on the TD reference vector 252 and/or the TI reference vector 254. Here, the FILM parameters 432 include a scaling vector (γ(e^{target}))) 434 and a shifting vector (β(e^{target})) 436 (collectively referred to as the FILM parameters 432). As will become apparent, the FiLM layer 424 uses the FILM parameters 432 to modulate an audio encoding 423. That is, the first example conditioning process 401a modulates the FiLM layer 424 using the FILM parameters 432 to generate the personal keyword detection model 420. For instance, the first example conditioning process 401a may obtain the speaker-agnostic keyword detection model 410 (not shown) as a baseline, then modulate the FILM layer 424 using the FILM parameters 432 to generate the personal keyword detection model 420. Stated differently, the FiLM generator 430 generates the FiLM parameters 432 based on an external conditioning input (e.g., the TD reference vector 252 and/or the TI reference vector 254) and output the FILM parameters 432 to the FiLM layer 350.

Moreover, the personal keyword detection model 420 may include an encoder 422, one or more FiLM layers 424, and a decoder 426. The encoder 422 may include a stack of multi-head self-attention blocks (e.g., conformer or transformer). The encoder 422 is configured to receive, as input, the audio data 120 corresponding to the utterance spoken by the user 10 and generate, as output, the audio encoding 423. Here, the utterance received by the encoder 422 may correspond to the enrollment utterances or the utterances 106 spoken by the users 10 during inference (FIGS. 1A and 1B). Thereafter, the FILM layer 424 receives the FILM parameters 432 generated by the FILM generator 430 based on the enrollment utterances and the audio encodings 423 generated by the encoder 422 and generate, as output, an affine transformation output (e.g., FiLM output) 425. The FILM layer 424 generates the affine transformation output by applying a feature-wise affine transformation (e.g., FiLM operation) to the audio encoding 423 using the FiLM parameters 432. Notably, the feature-wise affine transformation generalizes concatenation-based, biasing-based, and scaling-based conditioning operators which is more expressive in learning conditional representations than using any one individually.

In some implementations, the FILM layer 424 applies a different affine transformation to each feature of the audio encoding 423. In other implementations, the FiLM layer 424 applies a different affine transformation to each channel consistent across spatial locations (e.g., in a convolutional network configuration). For example, in these implementations, the FILM layer 424 first scales each feature (or channel) of the audio encoding 423 using the scaling vector (γ(e^{target}))) 434 and then shifts each feature (or channel) of the audio encoding 423 using the shifting vector (β(e^{target})) 436. In particular, the FILM layer 424 may generate the affine transformation output 425 according to:

$$F i L M ( h ) = γ ( {e}^{t a r g e t} ) * h + β ( {e}^{t a r g e t} ) \qquad ( 1 )$$

In Equation 1, FiLM (h) represents the affine transformation output 425, γ(e^{target}) represents the scaling vector 434, β (e^{target}) represents the shifting vector 436, and h represents the audio encoding 423.

The decoder 426 is configured to receive the affine transformation output 425 as input and generate, as output, the keyword indication 405 representing whether the audio data 120 includes the keyword. That is, the decoder 426 decodes the affine transformation output 425 to generate the keyword indication 405. When the keyword is not present in the audio data 120 the decoder 426 does not output the keyword indication 405. On the other hand, when the keyword is present, the decoder 426 outputs the keyword indication 405 to the ASR system 180 causing the ASR system 180 to perform speech recognition on the audio data 120.

Referring now to FIG. 4B, in some examples, a second example conditioning process 401, 401b uses the speaker characteristic information 250 that includes the reference audio data 253, 355 to condition the keyword detector 400. Here, the personal keyword detection model 420 includes the encoder 422, the decoder 426, and a cross-attention mechanism 428. The encoder 422 is configured to receive, as input, the audio data 120 corresponding to the utterance spoken by the user 10 and generate, as output, the audio encoding 423. Here, the utterance received by the encoder 422 may correspond to the enrollment utterances or the utterances 106 spoken by the users 10 during inference (FIGS. 1A and 1B). The cross-attention mechanism 428 receives the audio encoding 423 generated by the encoder 422 and the speaker characteristic information 250 (e.g., the TD reference audio data 253 and/or the TI reference audio data 255). The cross-attention mechanism 428 may include a stack of cross-attention layers such as conformer or transformer layers. Thus, the cross-attention mechanism 428 is configured to perform cross-attention between the audio encoding 423 and the TD reference audio data 253 and/or TI reference audio data 255 to generate, as output, a cross-attention output 429. Stated differently, the second example conditioning process 401b may initially obtain the speaker-agnostic keyword detection model 410 (not shown) and condition the cross-attention mechanism 428 by processing the TD reference audio data 253 and/or TI reference audio data 255 to generate the personal keyword detection model 420.

Notably, the cross-attention output 429 conditions the personal keyword detection model 420 to detect the presence of the keyword spoken by the particular user 10. The decoder 426 receives the cross-attention output 429 as input and generates, as output, the keyword indication 405 when the audio data 120 includes the keyword. Here, the decoder 426 outputs the keyword indication 405 to the ASR system 180 thereby causing the ASR system 180 to perform speech recognition on the audio data. Otherwise, the decoder 426 does not output the keyword indication 405 such that the ASR system 180 does not process the audio data 120.

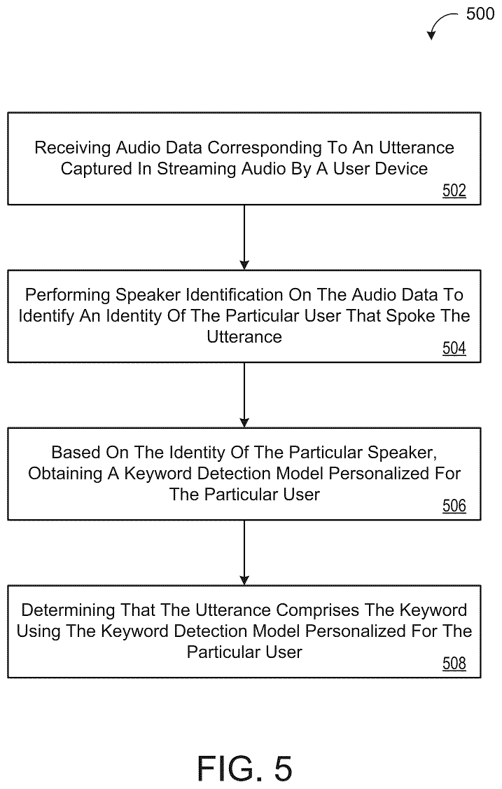

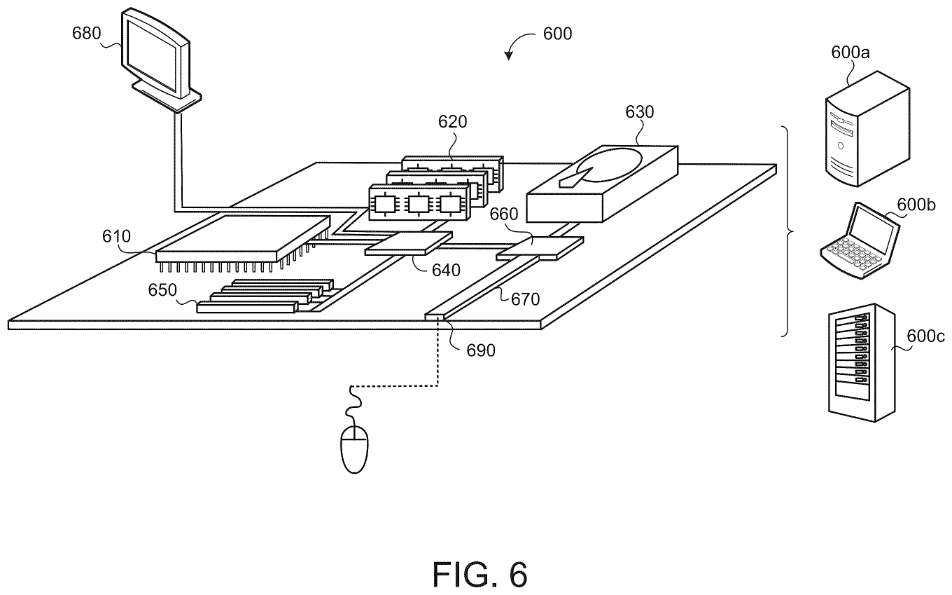

FIG. 5 illustrates a flowchart of an example flowchart of operations for a computer-implemented method 500 of performing target speaker keyword spotting. The method 500 may execute on data processing hardware 610 (FIG. 6) using instructions stored on memory hardware 620 (FIG. 6) that may reside on the user device 102 and/or the remote system 111 of FIG. 1 corresponding to a computing device 600 (FIG. 6). At operation 502, the method 500 includes receiving audio data 120 that

corresponds to an utterance 106 spoken by a user 10 and is captured in streaming audio 118 by a user device 102. Notably, the user 10 may be an enrolled user for the user device 102 such that the user device 102 stores speaker characteristic information 250 associated with the user 10. At operation 504, the method 500 includes performing speaker identification (e.g., using the speaker verification system 200) on the audio data 120 to identify an identity 205 of the particular user 10 that spoke the utterance 106. At operation 506, the method 500 includes obtaining a keyword detection model personalized for the particular user 10 (e.g., personal keyword detection model 420) that is conditioned on the speaker characteristic information 250 associated with the particular user 10. Here, the speaker characteristic information 250 may include enrollment reference vectors 252, 254 and/or enrollment reference audio data 253, 255 from audio samples of one or more enrollment phrases spoken by the particular enrolled user 10. At operation 508, the method 500 includes determining that the utterance 106 includes the keyword using the keyword detection model personalized for the particular user 10 (e.g., using the personal keyword detection model 420). As discussed above, the particular user 10 may have unique speech characteristics such that the speaker-agnostic keyword detection models 410 would be unable to accurately detect the presence of the keyword from the utterance. However, the personalized keyword detection model 420 is able to detect the keyword because the personalized keyword detection model 420 is conditioned on the speaker characteristic information 250 associated with the particular user.

FIG. 6 is a schematic view of an example computing device 600 that may be used to implement the systems and methods described in this document. The computing device 600 is intended to represent various forms of digital computers, such as laptops, desktops, workstations, personal digital assistants, servers, blade servers, mainframes, and other appropriate computers. The components shown here, their connections and relationships, and their functions, are meant to be exemplary only, and are not meant to limit implementations of the inventions described and/or claimed in this document.

The computing device 600 includes a processor 610, memory 620, a storage device 630, a high-speed interface/controller 640 connecting to the memory 620 and high-speed expansion ports 650, and a low speed interface/controller 660 connecting to a low speed bus 670 and a storage device 630. Each of the components 610, 620, 630, 640, 650, and 660, are interconnected using various busses, and may be mounted on a common motherboard or in other manners as appropriate. The processor 610 can process instructions for execution within the computing device 600, including instructions stored in the memory 620 or on the storage device 630 to display graphical information for a graphical user interface (GUI) on an external input/output device, such as display 680 coupled to high speed interface 640. In other implementations, multiple processors and/or multiple buses may be used, as appropriate, along with multiple memories and types of memory. Also, multiple computing devices 600 may be connected, with each device providing portions of the necessary operations (e.g., as a server bank, a group of blade servers, or a multi-processor system).

The memory 620 stores information non-transitorily within the computing device 600. The memory 620 may be a computer-readable medium, a volatile memory unit(s), or non-volatile memory unit(s). The non-transitory memory 620 may be physical devices used to store programs (e.g., sequences of instructions) or data (e.g., program state information) on a temporary or permanent basis for use by the computing device 600. Examples of non-volatile memory include, but are not limited to, flash memory and read-only memory (ROM)/programmable read-only memory (PROM)/erasable programmable read-only memory (EPROM)/electronically erasable programmable read-only memory (EEPROM) (e.g., typically used for firmware, such as boot programs).

Examples of volatile memory include, but are not limited to, random access memory (RAM), dynamic random access memory (DRAM), static random access memory (SRAM), phase change memory (PCM) as well as disks or tapes.

The storage device 630 is capable of providing mass storage for the computing device 600. In some implementations, the storage device 630 is a computer-readable medium. In various different implementations, the storage device 630 may be a floppy disk device, a hard disk device, an optical disk device, or a tape device, a flash memory or other similar solid state memory device, or an array of devices, including devices in a storage area network or other configurations. In additional implementations, a computer program product is tangibly embodied in an information carrier. The computer program product contains instructions that, when executed, perform one or more methods, such as those described above. The information carrier is a computer—or machine-readable medium, such as the memory 620, the storage device 630, or memory on processor 610.

The high speed controller 640 manages bandwidth-intensive operations for the computing device 600, while the low speed controller 660 manages lower bandwidth-intensive operations. Such allocation of duties is exemplary only. In some implementations, the high-speed controller 640 is coupled to the memory 620, the display 680 (e.g., through a graphics processor or accelerator), and to the high-speed expansion ports 650, which may accept various expansion cards (not shown). In some implementations, the low-speed controller 660 is coupled to the storage device 630 and a low-speed expansion port 690. The low-speed expansion port 690, which may include various communication ports (e.g., USB, Bluetooth, Ethernet, wireless Ethernet), may be coupled to one or more input/output devices, such as a keyboard, a pointing device, a scanner, or a networking device such as a switch or router, e.g., through a network adapter.

The computing device 600 may be implemented in a number of different forms, as shown in the figure. For example, it may be implemented as a standard server 600a or multiple times in a group of such servers 600a, as a laptop computer 600b, or as part of a rack server system 600c.

Various implementations of the systems and techniques described herein can be realized in digital electronic and/or optical circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” and “computer-readable medium” refer to any computer program product, non-transitory computer readable medium, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

The processes and logic flows described in this specification can be performed by one or more programmable processors, also referred to as data processing hardware, executing one or more computer programs to perform functions by operating on input data and generating output. The processes and logic flows can also be performed by special purpose logic circuitry, e.g., an FPGA (field programmable gate array) or an ASIC (application specific integrated circuit). Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, one or more aspects of the disclosure can be implemented on a computer having a display device, e.g., a CRT (cathode ray tube), LCD (liquid crystal display) monitor, or touch screen for displaying information to the user and optionally a keyboard and a pointing device, e.g., a mouse or a trackball, by which the user can provide input to the computer. Other kinds of devices can be used to provide interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

A number of implementations have been described. Nevertheless, it will be understood that various modifications may be made without departing from the spirit and scope of the disclosure. Accordingly, other implementations are within the scope of the following claims.

What is claimed is:

1. A computer-implemented method that when executed on data processing hardware causes the data processing hardware to perform operations comprising:
receiving audio data corresponding to an utterance spoken by a particular user and captured in streaming audio by a user device;
performing speaker identification on the audio data to identify an identity of the particular user that spoke the utterance;
based on the identity of the particular user that spoke the utterance, obtaining a keyword detection model personalized for the particular user, the keyword detection model conditioned on speaker characteristic information associated with the particular user to adapt the keyword detection model to detect a presence of a keyword in audio for the particular user; and
determining, using the keyword detection model personalized for the particular user, that the utterance comprises the keyword.

2. The computer-implemented method of claim 1, wherein the keyword detection model is personalized for the particular user by:
obtaining a speaker-agnostic keyword detection model, the speaker-agnostic keyword detection model trained to detect the presence of the keyword in audio;
receiving one or more enrollment utterances spoken by the particular user;
extracting, from the one or more enrollment utterances spoken by the particular user, a speaker embedding characterizing voice characteristics of the particular user; and
conditioning the speaker-agnostic keyword detection model on the speaker embedding, the speaker embedding comprising the speaker characteristic information associated with the particular user.

3. The computer-implemented method of claim 2, wherein:
the keyword detection model comprises a Feature-wise Linear Modulation (FiLM) layer; and
conditioning the speaker-agnostic keyword detection model comprises:
generating, using a FILM generator, FiLM parameters based on the speaker embedding; and
modulating the FILM layer of the speaker-agnostic keyword detection model using the FiLM parameters to provide the keyword detection model personalized for the particular user.

4. The computer-implemented method of claim 2, wherein extracting the speaker embedding comprises extracting a text-independent speaker embedding or a text-dependent speaker embedding.

5. The computer-implemented method of claim 2, wherein:
the speaker-agnostic keyword detection model comprises a stack of cross-attention layers; and
conditioning the speaker-agnostic keyword detection model comprises processing the one or more enrollment utterances using the stack of cross-attention layers to provide the keyword detection model personalized for the particular user.

6. The computer-implemented method of claim 1, wherein obtaining the keyword detection model personalized for the particular user comprises:
using the identity of the particular user, retrieving the speaker characteristic information associated with the particular user from memory hardware in communication with the data processing hardware; and
conditioning a speaker-agnostic keyword detection model on the speaker characteristic information associated with the particular user to provide the keyword detection model personalized for the particular user, the speaker-agnostic keyword detection model trained to detect the presence of the keyword in audio.

7. The computer-implemented method of claim 6, wherein the speaker characteristic information associated with the particular user is stored on the memory hardware and comprises one or more enrollment utterances spoken by the particular user.

8. The computer-implemented method of claim 6, wherein the speaker characteristic information associated with the particular is stored on the memory hardware and comprises a speaker embedding extracted from one or more enrollment utterances spoken by the particular user.

9. The computer-implemented method of claim 1, wherein the operations further comprise, in response to determining that the utterance comprises the keyword, processing, using a speech recognition model, the streaming audio.

10. The computer-implemented method of claim 1, wherein the utterance comprises a keyword followed by one or more other terms corresponding to a voice command.

11. A system comprising:
data processing hardware; and
memory hardware in communication with the data processing hardware, the memory hardware storing instruction that when executed on the data processing hardware cause the data processing hardware to perform operations comprising:
receiving audio data corresponding to an utterance spoken by a particular user and captured in streaming audio by a user device;
performing speaker identification on the audio data to identify an identity of the particular user that spoke the utterance;
based on the identity of the particular user that spoke the utterance, obtaining a keyword detection model personalized for the particular user, the keyword detection model conditioned on speaker characteristic information associated with the particular user to adapt the keyword detection model to detect a presence of a keyword in audio for the particular user; and
determining, using the keyword detection model personalized for the particular user, that the utterance comprises the keyword.

12. The system of claim 11, wherein the keyword detection model is personalized for the particular user by:
obtaining a speaker-agnostic keyword detection model, the speaker-agnostic keyword detection model trained to detect the presence of the keyword in audio;
receiving one or more enrollment utterances spoken by the particular user;
extracting, from the one or more enrollment utterances spoken by the particular user, a speaker embedding characterizing voice characteristics of the particular user; and
conditioning the speaker-agnostic keyword detection model on the speaker embedding, the speaker embedding comprising the speaker characteristic information associated with the particular user.

13. The system of claim 12, wherein:
the keyword detection model comprises a Feature-wise Linear Modulation (FILM) layer; and
conditioning the speaker-agnostic keyword detection model comprises:
generating, using a FILM generator, FiLM parameters based on the speaker embedding; and
modulating the FILM layer of the speaker-agnostic keyword detection model using the FILM parameters to provide the keyword detection model personalized for the particular user.

14. The system of claim 12, wherein extracting the speaker embedding comprises extracting a text-independent speaker embedding or a text-dependent speaker embedding.

15. The system of claim 12, wherein:
the speaker-agnostic keyword detection model comprises a stack of cross-attention layers; and
conditioning the speaker-agnostic keyword detection model comprises processing the one or more enrollment utterances using the stack of cross-attention layers to provide the keyword detection model personalized for the particular user.

16. The system of claim 11, wherein obtaining the keyword detection model personalized for the particular user comprises:
using the identity of the particular user, retrieving the speaker characteristic information associated with the particular user from the memory hardware in communication with the data processing hardware; and
conditioning a speaker-agnostic keyword detection model on the speaker characteristic information associated with the particular user to provide the keyword detection model personalized for the particular user, the speaker-agnostic keyword detection model trained to detect the presence of the keyword in audio.

17. The system of claim 16, wherein the speaker characteristic information associated with the particular user is stored on the memory hardware and comprises one or more enrollment utterances spoken by the particular user.

18. The system of claim 16, wherein the speaker characteristic information associated with the particular is stored on the memory hardware and comprises a speaker embedding extracted from one or more enrollment utterances spoken by the particular user.

19. The system of claim 11, wherein the operations further comprise, in response to determining that the utterance comprises the keyword, processing, using a speech recognition model, the streaming audio.

20. The system of claim 11, wherein the utterance comprises a keyword followed by one or more other terms corresponding to a voice command.
